(19) United States
(12) Patent Application Publication
(10) Pub. No.: US 2011/0128235 A1
(43) Pub. Date: Jun. 2, 2011

(54) BIG KEY TOUCH INPUT DEVICE

(75) Inventors: William Rogers, Minneapolis, MN (US); Steve Grothe, Cave Creek, AZ (US)

(73) Assignee: HONEYWELL INTERNATIONAL INC., Morristown, NJ (US)

(21) Appl. No.: 12/627,123

(22) Filed: Nov. 30, 2009

(51) Int. Cl. G06F 3/041

(52) U.S. Cl. 345/173

(57) ABSTRACT

An apparatus (107, 300) and method (600) for selecting one of a plurality of symbols from a plurality of keys (302-311, 602), includes applying a digit to one of the keys (302-311, 602), wherein each of the keys (302-311, 602) include at least two of the plurality of symbols, and swiping a digit across the key in the direction of one of the at least two symbols to select the one symbol.

### FIELD OF THE INVENTION

The present invention generally relates to inputting symbols represented by alphanumeric labels or graphic icons, and more particularly to the selection of an alphanumeric character or a menu item from a plurality of alphanumeric characters, icons, or menu items on a big key input device having a plurality of alphanumeric characters, icons, or menu items on each key.

### BACKGROUND OF THE INVENTION

Many electronic devices, such as aircraft flight deck operational equipment including touch panels (including both opaque touch panels and transparent touch screens), receive input from the aircrew. A touch panel offers intuitive inputting for a computer or other data processing devices. It is especially useful in aircraft cockpit devices where other input devices, such as a keyboard and a mouse, are not easily available.

Touch panels are increasingly being used in the cockpit instead of cursor control devices (CCDs), hard knobs and switches, and hardware keyboards. For alphanumeric input using a touch screen, a virtual keyboard is typically displayed and the user touches the appropriate keys analagous to pushing keys on a real keyboard. However, many of the known panels particularly suited for low end general aviation applications, are relatively small and the use of a full keyboard makes each key so small that unacceptable accuracy of the touch may occur, especially during turbulence or with the use of gloves by the aircrew. These known touch panels require the aircrew's attention over an inordinate amount of time, thereby distracting them from performing other flight duties.

There are many types of touch panel sensing technologies, including capacitive, resistive, infrared, and surface acoustic wave. All of these keyboard technologies sense touches on a screen. U.S. Pat. No. 6,492,979 discloses the use of a combination of capacitive touch screen and force sensors. U.S. Pat. No. 7,196,694 discloses the use of force sensors at the peripherals of the touch screen to determine the position of a touch. US patent publication 2007/0229464 discloses the use of a capacitive force sensor array, overlaying a display to form a touch screen. However, none of these known teachings disclose how to select one of a plurality of characters using a single key.

World wide air traffic is projected to double every ten to fourteen years and the International Civil Aviation Organization (ICAO) forecasts world air travel growth of five percent per annum until the year 2020. Such growth may cause degradation in safety and performance and an increase in an already high workload of the flight crew. One negative influence on flight performance has been the ability for the aircrew to input data while paying attention to other matters within and outside of the cockpit. The ability to easily and quickly input data can significantly improve situational awareness of the flight crew resulting in increased flight safety and performance by reducing the flight crew workload.

Accordingly, it is desirable to provide an apparatus and method for inputting alphanumeric characters, symbols, or menu items from a plurality of such on a small touch panel having keys sufficiently large for accurate selection. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method for selecting one of a plurality of symbols from a plurality of keys, includes applying a digit to one of the keys, wherein each of the keys include at least two of the plurality of symbols, and swiping a digit across the key in the direction of one of the at least two symbols to select the one symbol.

An input device for selecting a symbol, includes a touch panel keyboard and a processor. The touch panel keyboard has at least one key including a face having two or more of a plurality of symbols disposed thereupon, and sensing circuitry disposed within the at least one key that differentiates the position of the two or more symbols, wherein the sensing circuitry is configured to sense the application of a digit to the face and sense the movement of the digit across the face in the direction of the symbol. The processor is coupled to the sensing circuitry and configured to map the movement of the digit and determine the symbol identified by the mapped movement.

### BRIEF DESCRIPTION OF THE DRAWINGS

The present invention will hereinafter be described in conjunction with the following drawing figures, wherein like numerals denote like elements, and

FIG. 1 is a block diagram of a known aircraft system for presenting images on a display;

FIG. 2 is a diagram of a known alphanumeric touch panel;

FIG. 3 is diagram of an alphanumeric touch panel in accordance with an exemplary embodiment;

FIG. 4 is a diagram of one key of the alphanumeric touch panel of FIG. 3 in accordance with an exemplary embodiment;

FIG. 5 is a partial perspective view of exemplary circuitry for determining the touching and movement of a digit on the key of FIG. 4;

FIG. 6 is a diagram of one key of a menu in accordance with an exemplary embodiment; and

FIG. 7 is a flow chart of the steps in accordance with the exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A keyboard touch panel is disclosed having a plurality of keys, each key containing a plurality of symbols. Symbols as used herein is defined to include alphanumeric characters, icons, signs, words, terms, and phrases. For example, by disposing multiple alphanumeric characters on one key allows for fewer keys, and therefore larger keys, to occupy the same space as typical alphanumeric touch panels. A particular alphanumeric character is selected by sensing the application of a digit, such as a finger or a stylus, to the key containing that character. The digit is then swiped, or moved, in a direction of the particular desired character, characters, or symbol. Each key includes touch sensing circuitry disposed within for sensing the application and movement of the digit in the direction of a particular alphanumeric character from the center of the key.

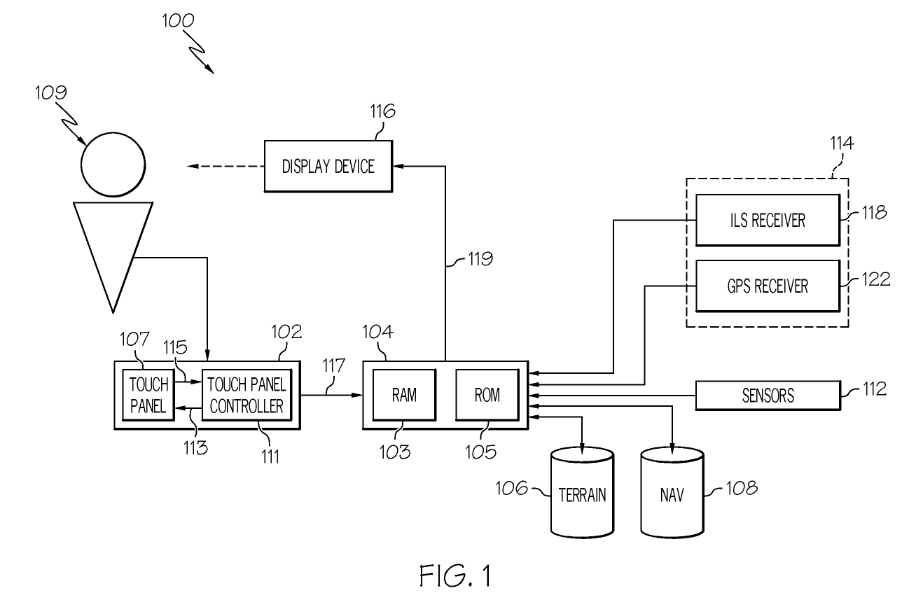

Referring to FIG. 1, a flight deck display system 100 includes a user interface 102, a processor 104, one or more terrain databases 106 sometimes referred to as a Terrain Avoidance and Warning System (TAWS), one or more navigation databases 108, various sensors 112, various external data sources 114, and one or more display devices 116. The user interface 102 is in operable communication with the processor 104 and is configured to receive input from a user 109 (e.g., a pilot) and, in response to the user input, supply command signals to the processor 104. The user interface 102 may be any one, or combination, of various known user interface devices including, but not limited to, one or more buttons, switches, or knobs (not shown). In the depicted embodiment, the user interface 102 includes a touch panel 107 and a touch panel controller 111. The touch panel controller 111 provides drive signals 113 to a touch panel 107, and a sense signal 115 is provided from the touch panel 107 to the touch panel controller 111, which periodically provides a signal 117 of the distribution of pressure to the processor 104. The processor 104 interprets the controller signal 117, determines the direction of movement of the digit on the touch panel 107, and provides, for example, a signal 119 to the display 116. Therefore, the user 109 uses the touch panel 107 to input alphanumeric data as more fully described hereinafter.

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. The software executing the exemplary embodiment is stored in either the ROM 105 or the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used.

No matter how the processor 104 is specifically implemented, it is in operable communication with the terrain databases 106, the navigation databases 108, and the display devices 116, and is coupled to receive various types of inertial data from the various sensors 112, and various other avionics-related data from the external data sources 114. The processor 104 is configured, in response to the inertial data and the avionics-related data, to selectively retrieve terrain data from one or more of the terrain databases 106 and navigation data from one or more of the navigation databases 108, and to supply appropriate display commands to the display devices 116. The display devices 116, in response to the display commands, selectively render various types of textual, graphic, and/or iconic information. The preferred manner in which the textual, graphic, and/or iconic information are rendered by the display devices 116 will be described in more detail further below.

The terrain databases 106 include various types of data representative of the terrain over which the aircraft is flying, and the navigation databases 108 include various types of navigation-related data. The sensors 112 may be implemented using various types of inertial sensors, systems, and or subsystems, now known or developed in the future, for supplying various types of inertial data, for example, representative of the state of the aircraft including aircraft speed, heading, altitude, and attitude. The ILS provides aircraft with horizontal (or localizer) and vertical (or glide slope) guidance just before and during landing and, at certain fixed points, indicates the distance to the reference point of landing on a particular runway. The GPS receiver 122 is a multi-channel receiver, with each channel tuned to receive one or more of the GPS broadcast signals transmitted by the constellation of GPS satellites (not illustrated) orbiting the earth.

The display devices 116, as noted above, in response to display commands supplied from the processor 104, selectively renders various textual, graphic, and/or iconic information, and thereby supplies visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display devices 116 may additionally be implemented as a panel mounted display, a HUD (head-up display) projection, or any one of numerous known technologies. It is additionally noted that the display devices 116 may be configured as any one of numerous types of aircraft flight deck displays. For example, it may be configured as a multi-function display, a horizontal situation indicator, or a vertical situation indicator, just to name a few. In the depicted embodiment, however, one of the display devices 116 is configured as a primary flight display (PFD).

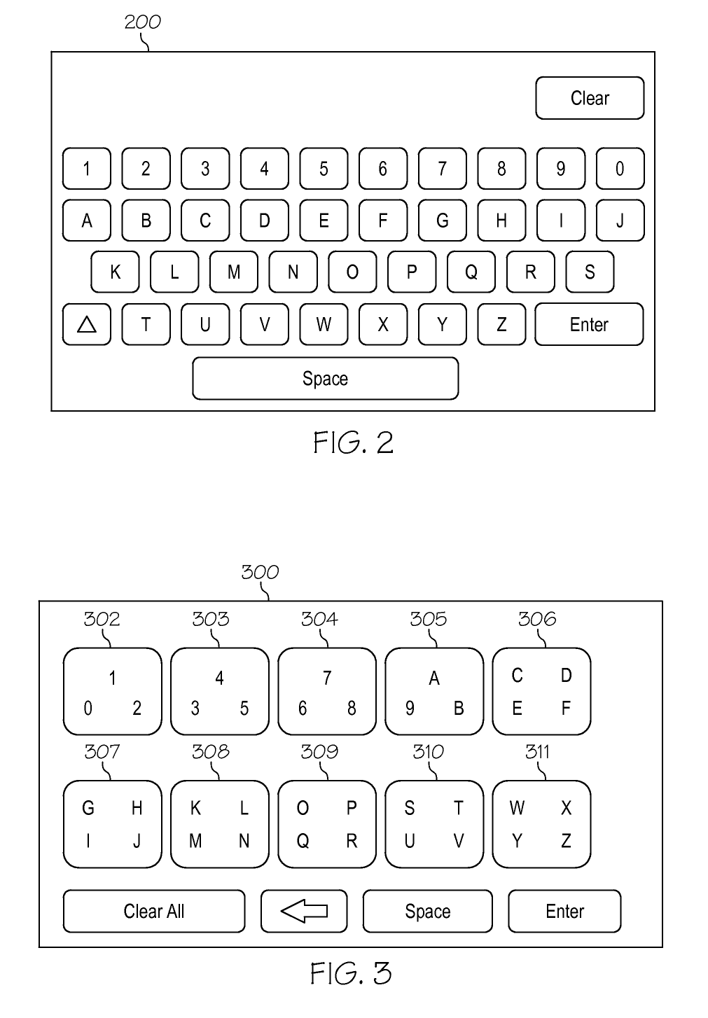

A typical alphanumeric touch panel 200 is shown in FIG. 2 and includes forty keys having a key for each of the numbers “1” through “0”, the letters “A” through “Z”, the functions “CLEAR”, “ENTER”, “Space”, and an up arrow.

In accordance with a first exemplary embodiment, the touch panel 300 shown in FIG. 3 includes fourteen keys. In addition to the function keys “ENTER”, “SPACE”, “Clear All”, and “return”, the following keys contain the identified alphanumeric characters:

| KEY | CHARACTER |
|---|---|
| 302 | 0, 1, 2 |
| 303 | 3, 4, 5 |
| 304 | 6, 7, 8 |
| 305 | 9, A, B |
| 306 | C, D, E, F |
| 307 | G, H, I, J |
| 308 | K, L, M, N |
| 309 | O, P, Q, R |
| 310 | S, T, U, V |
| 311 | W, X, Y, Z |

The desired character on each of these keys 302 through 311 is selected by touching the key and then swiping, or moving, the finger across the face of the key in the direction (heading in degrees) of the desired character from the center of the key.

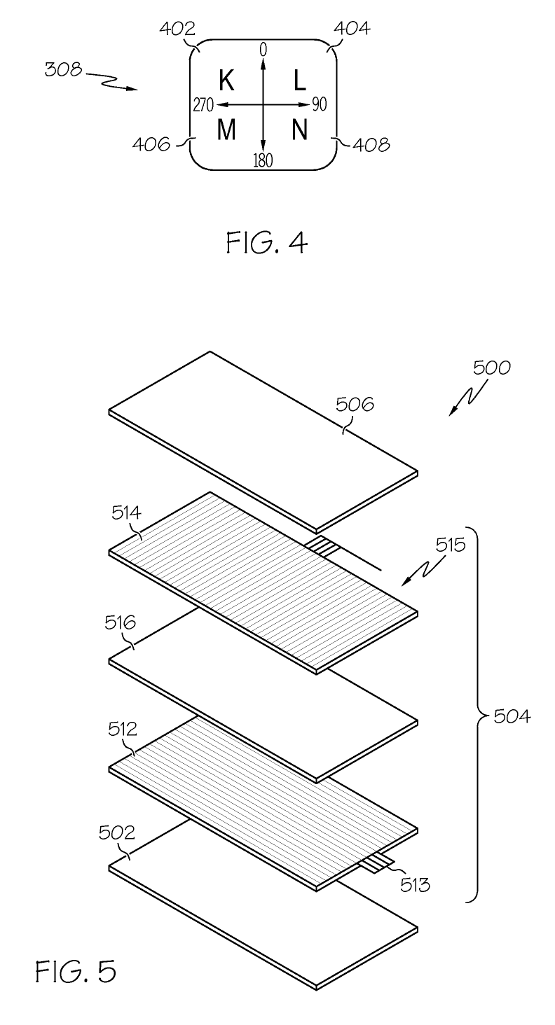

FIG. 4 is the key 308 containing the characters K, L, M, and N as an example. Since the key contains four characters, it defines four directions from the center of the key 408. For example, the character “K” is in the upper left section (or quadrant in the case of four characters) which may be defined as from 270 to 0 (or 360) degrees from the center of the key. The character M is in the lower left section, or from 180 to 270 degrees from the center of the key. Other keys may have a different number of sections, for example, key 302 containing the characters 0, 1, 2 would have only three sections wherein the character “1” is in the direction from 300 to 60 degrees, “2” is from 60 to 180 degrees, and “0” is from 180 to 300 degrees. The number of sections in a key generally would be two or more.

Referring to FIG. 5, each key includes a substrate 502, circuitry 504, and a key material 506. The key material includes a face, or surface, 508 upon which the alphanumeric characters are formed, for example, by printing or molding in the case of an opaque key or by display in the case of a touch screen. The key material 506 is preferably a polymer, or any hard surface. The circuitry 504 may be any sensing technologies, including capacitive, projective capacitance, resistive, infrared, and surface acoustic wave, that senses a touch by a digit. A digit is defined herein as including a stylus, a finger, a finger enclosed in a material such as a glove, and any object that may be used to touch the key. When the keys 302-311 are formed as a touch screen, the substrate 502, circuitry 504, and key material 506 would be formed of a transparent substrate, of glass or a polymer, for example, and a display generating device (not shown) such as a liquid crystal display would be positioned between the substrate 502 and the key material 506. Those skilled in the art will appreciate that other types of imaging devices 500 may be utilized as exemplary embodiments, including, for example, transmissive, reflective or transflective liquid crystal displays, cathode ray tubes, micromirror arrays, and printed panels.

The circuitry 504 includes two or more layers of patterned conductive traces 512, 514 deposited over the substrate. A flexible material 516 is deposited between the first and second patterned conductive traces at the intersection of each first and second conductive traces. The flexible material 516 is a continuous layer and, in the touch screen embodiment, preferably has a transparent elastomeric matrix, such as polyester, phenoxy resin, or silicone rubber.

The conductive traces 512, 514 are coupled to the touch panel controller through tabs 513, 515, respectively. By scanning the rows and columns of the conductive traces 512, 514 and mapping the resistance of the flexible material 516 at each intersection, a corresponding pressure map of the touch screen may be obtained. This map provides both the position and the movement of the corresponding touch.

By being able to sense this change in resistance as the digit moves across the face 508 due to pressure being applied to the pressure sensor 500, the selection of the appropriate alphanumeric character may be accomplished. The change in resistance between the traces 512, 514 is sensed and provided to the touch panel controller 111 and then to the processor 104. A mapping of the moving resistance change is accomplished and a direction is determined In the case of key 308 (FIG. 4), if the determined direction is 117 degrees, the alphanumeric character “N” is provided as output to the display 116. The finger swiping concept allows the location of the initial touch to be anywhere on the key, e.g., it may be on any of the segments or on the border between segments, and the appropriate character is selected as long as the movement is in the compass direction commensurate with the relative position of the intended character. A user could actually touch the “K” “M” or “L” sections or the border between them and then with a short 135 degree directional swipe would select the “N”. The “N” section may not even be touched—it is the direction of the swipe that selects the character, not the initial touch point.

While a touch panel is shown wherein the direction of the swipe is determined by a change in resistance, there are many other technologies available that could be used, including InfraRed and capacitive. And while alphanumeric characters are illustrated in the above exemplary embodiment, a key could contain any two or more symbols, including, for example, alphanumeric characters, icons, signs, words, terms, and phrases, either alone or in combination.

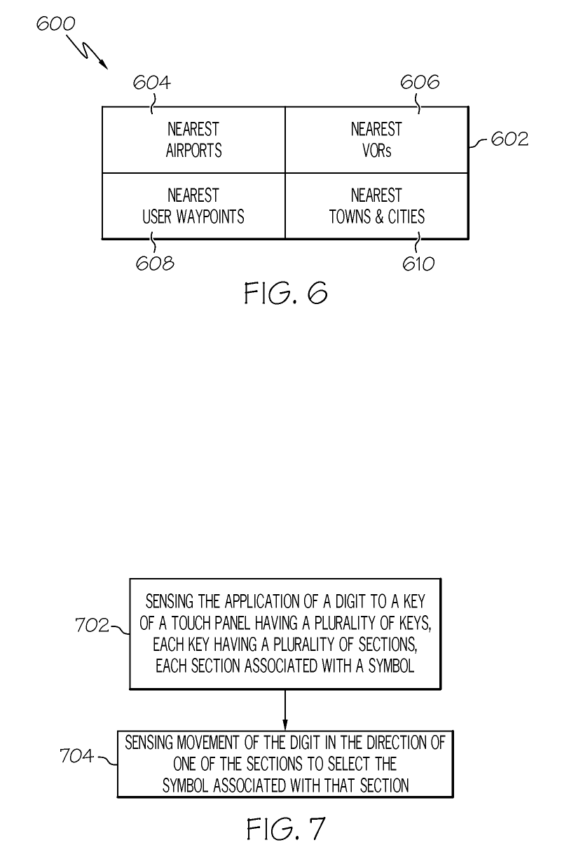

Another exemplary embodiment, of a menu 600, is shown in FIG. 6, including four menu items for selection defining four directions from the center of the key 602. For example, the menu items “NEAREST AIRPORT” 604 occupies the upper left section which may be defined as from 270 to 360 degrees from the center of the key, “NEAREST VORs” 606 occupies the upper right section from 0 to 90 degrees, “NEAREST TOWNS AND CITIES” 608 occupies the lower right from 90 to 180 degrees, and “NEAREST USER WAYPOINTS” 610 occupies the lower left from 180 to 270 degrees. By being able to sense movement of the digit as it moves across the face of the key 602, the selection of the appropriate menu item may be accomplished. The direction is sensed and provided to the touch panel controller 111 and then to the processor 104. A mapping of the movement is accomplished and a direction is determined. In the case of key 600 (FIG. 4), if the determined direction is 345 degrees, the menu item “NEAREST AIRPORT” is selected as the information to be displayed on the display 116. The finger swiping concept allows the location of the initial touch to be anywhere on the key, e.g., it may be on any of the segments or on the border between segments, and the appropriate character is selected as long as the movement is in the compass direction commensurate with the relative position of the intended character. A user could actually touch any one of the four sections or the border between them and then with a short 345 degree directional swipe would select the “NEAREST AIRPORT” menu item. The “NEAREST AIRPORT” section may not even be touched—it is the direction of the swipe that selects the menu item, not the initial touch point.

Referring to FIG. 7, the method of the exemplary embodiments includes the steps of sensing 702 the application of a digit to a key of a touch panel having a plurality of keys, each key having a plurality of sections, each section associated with an alphanumeric character, and sensing 704 movement of the digit in the direction of one of the sections to select the alphanumeric character associated with that section.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for selecting one of a plurality of symbols from a plurality of keys, comprising:
applying a digit to one of the keys, wherein each of the keys include at least two of the plurality of symbols; and
swiping a digit across the key in the direction of one of the at least two symbols to select the one symbol.

2. The method of claim 1 wherein the plurality of symbols comprises a plurality of alphanumeric characters and the swiping step comprises:
selecting an alphanumeric character.

3. The method of claim 1 wherein the plurality of symbols comprises a plurality of menu items and the swiping step comprises:
selecting a menu item.

4. The method of claim 1 wherein each of the symbols define a section of the key defined by degrees from a center of the key.

5. The method of claim 1 wherein the applying step comprises:
applying a finger.

6. The method of claim 1 wherein the applying step comprises:
applying a stylus.

7. The method of claim 1 wherein the swiping step comprises:
mapping a movement of the digit across the key to determine a direction.

8. The method of claim 1 wherein the swiping step comprises:
mapping a movement of the digit across the key to determine a direction in degrees from a center of the key based on a zero degree reference line.

9. A method for selecting one of a plurality of symbols from a plurality of keys, wherein each of the keys comprise a face having a plurality of sections wherein each of the sections have one of the plurality of symbols associated therewith, the method comprising:
sensing the application of a digit to one of the keys by sensor circuitry disposed within the first and second sections; and
sensing movement of the digit across the key in a direction of one of the sections to select the one of the plurality of symbols associated with that section, the direction being defined from the center of the key.

10. The method of claim 9 wherein the plurality of symbols comprises a plurality of alphanumeric characters and the sensing movement step comprises:
selecting an alphanumeric character.

11. The method of claim 9 wherein the plurality of symbols comprises a plurality of menu items and the sensing movement step comprises:
selecting a menu item.

12. The method of claim 9 wherein the sensing movement step comprises:
mapping a movement of the digit across the key to determine a direction in degrees from a center of the key based on a zero degree reference line.

13. An input device for selecting a symbol, comprising:
a touch panel keyboard having at least one key, the at least one key comprising:
a face having two or more of a plurality of symbols disposed thereupon; and
sensing circuitry disposed within the at least one key that differentiates the position of the two or more symbols, the sensing circuitry configured to:
sense the application of a digit to the face; and
sense the movement of the digit across the face in the direction of the symbol;
a processor coupled to the sensing circuitry and configured to:
mapping the movement of the digit; and
determine the symbol identified by the mapped movement.

14. The input device of claim 13 wherein the sensing circuitry comprises a technology selected from one of the group consisting of capacitive, resistive, infrared, and surface acoustic wave.

15. The input device of claim 13 wherein the keyboard comprises:
a touch screen.

16. The input device of claim 13 wherein the processor is further coupled to an aircraft flight deck system.

17. The method of claim 13 wherein the plurality of symbols comprises:
a plurality of alphanumeric characters.

18. The method of claim 13 wherein the plurality of symbols comprises a plurality of menu items.

19. The method of claim 13 wherein the processor is configured to map a movement of the digit across the key to determine a direction in degrees from a center of the key based on a zero degree reference line.

20. The method of claim 13 wherein the position of the two or more symbols are differentiated by degrees from the center of the key based on a zero degree reference line.
